(19) United States
(12) Patent Application Publication
(10) Pub. No.: US 2005/0079282 A1
(43) Pub. Date: Apr. 14, 2005

(54) Ultra-high-density magnetic recording media and methods for making the same

(76) Inventor: Sungho Jin, San Diego, CA (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/969,273

(22) Filed: Oct. 20, 2004

Related U.S. Application Data
(63) Continuation-in-part of application No. 10/262,462, filed on Sep. 30, 2002.

(51) Int. Cl. B05D 5/12

(52) U.S. Cl. 427/126.6; 427/127; 427/97.7

(57) ABSTRACT

In accordance with the invention, a high density recording medium is fabricated by novel methods. The medium comprises an array of nanomagnets disposed within a matrix or on the surface of substrate material. The nanomagnets are advantageously substantially perpendicular to a planar surface. The nanomagnets are preferably nanowires of high coercivity magnetic material inside a porous matrix or an array of vertically aligned nanotubes, or on the surface of flat substrate. Such media can provide ultra-high density recording with bit size less than 50 nm and even less than 20 nm. A variety of techniques are described for making such media.

### CROSS-REFERENCE TO RELATED APPLICATIONS

This application is a continuation-in-part of U.S. patent application Ser. No. 10/262,462 filed by Sungho Jin on Sep. 30, 2002 and entitled “Ultra-High-Density Information Storage”, which is incorporated herein by reference.

### FIELD OF THE INVENTION

This invention relates to media for storing information and, in particular, to high-density information storage media and methods for making the same.

### BACKGROUND OF THE INVENTION

Magnetic recording is an important part of modem computer technology. Conventional magnetic recording systems such as computer hard disk drives typically use a continuous magnetic thin film on a rigid substrate as the recording medium. Each bit of information is stored by magnetizing a small area on the magnetic film using a write head that provides a writing magnetic field. The magnetization strength and the location of each magnetic bit should be defined precisely to allow a flying magnetic sensor (read head) to retrieve the written information.

Each magnetic bit in the magnetic recording medium contains one magnetized region that consists of many small magnetized grains. Because of the trend toward higher recording density, the magnetic bit size is continuously being reduced. In order to reduce the size of the magnetic bits while maintaining a satisfactory signal-to-noise ratio, the size of the grains is also being reduced. Unfortunately, substantial reduction of the size of the weakly coupled magnetic grains will make their magnetization unstable due to the superparamagnetic phenomena occurring at ambient operating temperatures.

In order to overcome superparamagnetic limits, patterned magnetic media with discrete magnetic regions have been prepared. See U.S. Pat. No. 5,820,769 to Chou et al., U.S. Pat. No. 5,5587,223 to White et al., and U.S. Pat. No. 6,440,520 B1 to Baglin et al.

In patterned magnetic media, the conventional continuous magnetic film that covers the rigid disk substrate is replaced by an array of discrete magnetic regions, each of which serves as a single magnetic bit. Typical prior art approaches for preparing patterned magnetic media include photolithography, laser interference lithography and electron beam lithography. The lithographic techniques are used to form isolated regions of magnetic material surrounded by areas of non-magnetic material. See C. A. Ross et al., “Micromagnetic behavior of electrodeposited cylinder arrays”, Phy. Rev., Vol. B65, p. 1417 (2002).

Conventional photolithography and laser interference lithography are more convenient than the e-beam lithography. They produce fine, discrete magnetic structures. The bit size, however, is typically larger than ˜100 nm. Hence the magnetic recording density is unduly limited.

Electron beam lithography is capable of producing a finer structure with a bit size as small as ˜10 nm. However, current electron beam lithography with a single-beam writing process is a slow, expensive process which is not amenable to industrial mass production.

Desirable nanomagnet arrays can also be obtained using porous anodic alumina membranes containing periodically arranged vertical pores. (The term “nano” as used herein, refers to components having sub-100 nm operative dimensions). Cobalt or iron nanomagnet wire arrays so fine as ˜10-15 nm diameter have been obtained by electroplating magnetic metals into such pores. See H. Zeng et al., “Magnetic properties of self-assembled nanowires of varying length and diameter”, J. of Appl. Physics, Vol. 87, p. 4718 (2000), and Y. Peng et al., “Magnetic properties and magnetization reversal of alpha-iron nanowires deposited in alumina film”, J. of Appl. Physics, Vol. 87, p. 7405 (2000). However, the aluminum oxide membrane is a fragile, brittle structure that can easily break or distort from the flat surface required of a magnetic hard disk. The disk must be sufficiently flat that a flying read/write head can slide over it with a gap distance of less than ˜30 nm. The difficulty of filling nanopores with aqueous solution against surface tension of liquid, especially for nanopores of ˜50 nm or smaller in diameter, often causes reliability and reproducibility problems from pore to pore.

Carbon nanotubes have been used as a template to deposit nanowires of magnetic material. Various techniques were utilized—arc discharge synthesis (by M. Terrones, MRS Bulletin, Vo. 24, No. 8, page 43, August 1999), metal impregnation by electrolysis (by Ye, et al, Advanced Materials, Vol. 15, page 316, 2003), high temperature decomposition of metal-containing salt (by Govindaraj et al., Chemistry of Materials, Vol. 12, page 202, 2000), two-step deposition consisting of thermal decomposition deposition of carbon tubules and then MOCVD deposition of Ni nanowires into the vertical pores of anodic aluminum oxide membrane, followed by etching of alumina membrane, (by Pradhan et al, Chemical Communications, Issue 14, page 1317, 1999), and decomposition of (Co, C)-containing precursor (by Liu et al, Chemistry of Materials Vol. 12, page 2205, 2000). However, most of these techniques use loose, isolated nanotubes, instead of aligned and fixed nanotubes, so the magnetic metal filled nanotubes are randomly configured and the desired periodic arrangement and vertical alignment of nanomagnets suitable for magnetic recording media can not be achieved.

Accordingly there is a need to create ultrafine scale, nano-magnets in an aligned parallel array configuration on a solid substrate manner in order to fabricate industrially viable ultra-high-density magnetic recording media.

### SUMMARY OF THE INVENTION

In accordance with the invention, a high density recording medium is fabricated by novel methods. The medium comprises an array of nanomagnets disposed within a matrix or on the surface of a substrate material. The nanomagnets are advantageously substantially perpendicular to a planar surface. The nanomagnets are preferably nanowires of high coercivity magnetic material inside a porous matrix or an array of vertically aligned nanotubes, or on the surface of flat substrate. Such media can provide ultra-high density recording with bit size less than 50 nm and preferably less than 20 nm. A variety of techniques are described for making such media.

### BRIEF DESCRIPTION OF THE DRAWINGS

The nature, advantages and various additional features of the invention will appear more fully upon consideration of the illustrative embodiments now to be described in detail with the accompanying drawings. In the drawings:

FIG. 1 schematically illustrates a first embodiment of an improved magnetic recording medium in accordance with the invention;

FIG. 2 is a schematic block diagram of a first inventive method of making the medium of FIG. 1;

FIG. 3 schematically illustrates various stages of the process of FIG. 2;

FIG. 4 schematically shows a second method of making an improved magnetic recording medium utilizing selective preferential attachment of deposited atoms on magnetic Islands;

FIG. 5 schematically illustrates manipulating the growth direction of nanomagnets during physical vapor deposition by applied magnetic field;

FIG. 6 shows forming elongated nanomagnet array using oblique incident deposition of magnetic metal or alloy;

FIG. 7 illustrates forming an alloy nanomagnet array by using differential surface wetting on substrate surface;

FIG. 8 schematically shows filling vertical nanopores with magnetic nanomagnet alloy material using supercritical carbon dioxide deposition;

FIG. 9 schematically illustrates filling nanopores using thin film deposition and selective surface cleaning in porous silicon substrate;

FIG. 10 shows a method similar to FIG. 9 applied to an anodized oxide membrane attached on a solid substrate;

FIG. 11 illustrates utilizing a planar nanoparticle array as nanomask for lithographic definition of nanostructures;

FIG. 12 schematically shows a patterned array of nanomagnets with soft magnetic underlayer or under-island;

FIG. 13 schematically illustrates a magnetic recording scheme involving single nanomagnet per information bit in ultra-high-density magnetic recording media;

FIG. 14 schematically illustrates an alternative embodiment of magnetic recording scheme involving a multiplicity of nanomagnets per information bit in ultra-high-density magnetic recording media;

It is to be understood that these drawings are for the purpose of illustrating the concepts of the invention and are not to scale.

### DETAILED DESCRIPTION OF THE INVENTION

This invention describes the structure and fabrication of recording media particularly useful for high-density recording. By “high-density recording”, is meant recording at 50-nanometer information bit size or less, and preferentially 20 nanometer bit size or less.

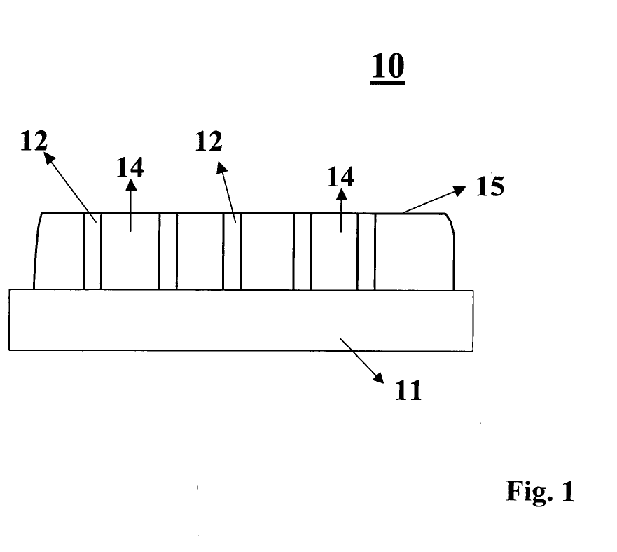

Referring to the drawings, FIG. 1 illustrates an exemplary magnetic recording medium 10 comprising a substrate 11, a plurality of magnetic nanowires 12 disposed substantially perpendicular to the substrate and a nonmagnetic filler material 14 disposed in spaces between the magnetic nanowires. (The term “nanowires” is used herein generically to encompass both true nanowires (solid cores) and nanotubes (hollow cores)). The magnetic nanowires 12 can comprise nanowires of magnetic material or nonmagnetic nanowires, such as carbon nanotubes, nanosilicon fibers, or nanometal wires, that are coated with magnetic material. It can also include nanotubes that are filled with magnetic material. The medium 10 is advantageously provided with a planarized surface 15 substantially perpendicular to nanowires 12. Preferably the nanowires are arranged in a substantially regular array.

In this embodiment, the conventional magnetic disk material comprising a continuous magnetic film is no longer utilized. Instead, a plurality of discrete, nanoscale magnetic elements 12 are employed to overcome the superparamagnetic limits in recording density. Each discrete magnetic element, or several elements as a block, can be magnetized along the same direction, thus constituting a magnetic bit. Each of the 12 elements are preferably separated from other elements by a nonmagnetic matrix material 14. The inter-element spacing is kept large enough to minimize exchange interaction between neighboring elements. Each magnetic element 12 preferably has the same size and shape, and is preferably made of the same magnetic material.

The elements 12 are preferably regularly arranged on the substrate, although it is not an absolute requirement where plural elements are magnetized and used as a single bit. Each magnetic element has a small size and a preferred shape anisotropy so that the magnetization of each discrete magnetic element will be automatically aligned along the long axis of the anistropic element. Instead of shape anisotropy, crystal anisotropy can also be utilized to align the magnetic moment of the discrete element preferentially along the vertical direction. This means that the magnetic moments of each nano-scale discrete magnetic element 12 is quantized and has only two states with the same magnitude but two opposite directions. Such a discrete magnetic element can be a single magnetic domain. Each direction of a quantized magnetic moment represents one value of a binary bit. A magnetic recording (or writing) operation involves flipping the magnetic moment direction of the single domain element. A reading operation involves sensing the quantized magnetic moments. The moments are preferably oriented perpendicular to the medium surface rather than longitudinally along the surface. A magnetic storage system, such as a hard disk system in a computer, consists of the magnetic storage medium, write heads, and read heads.

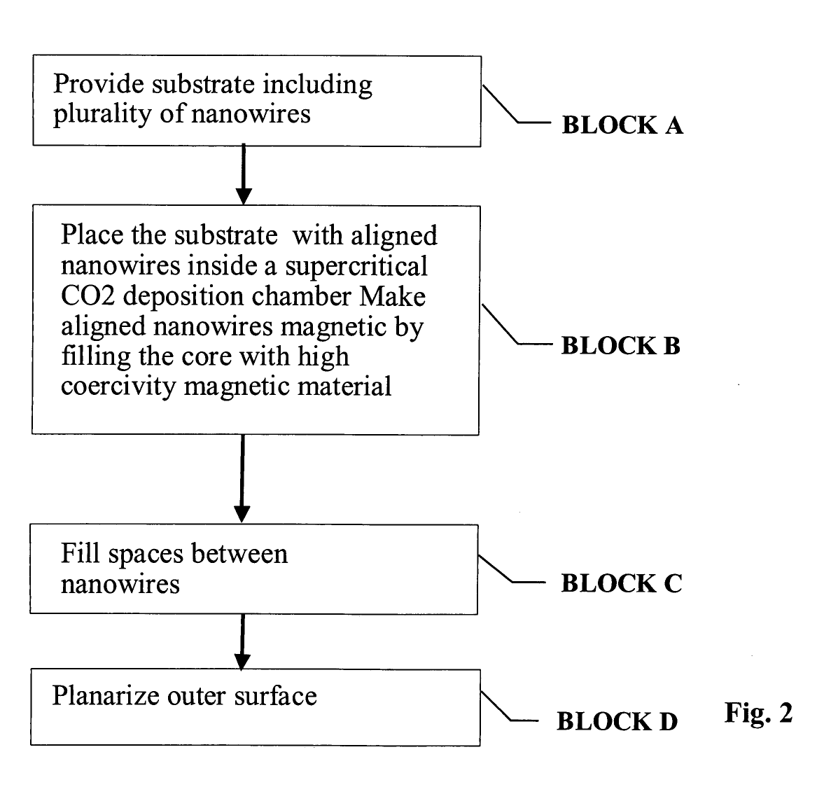

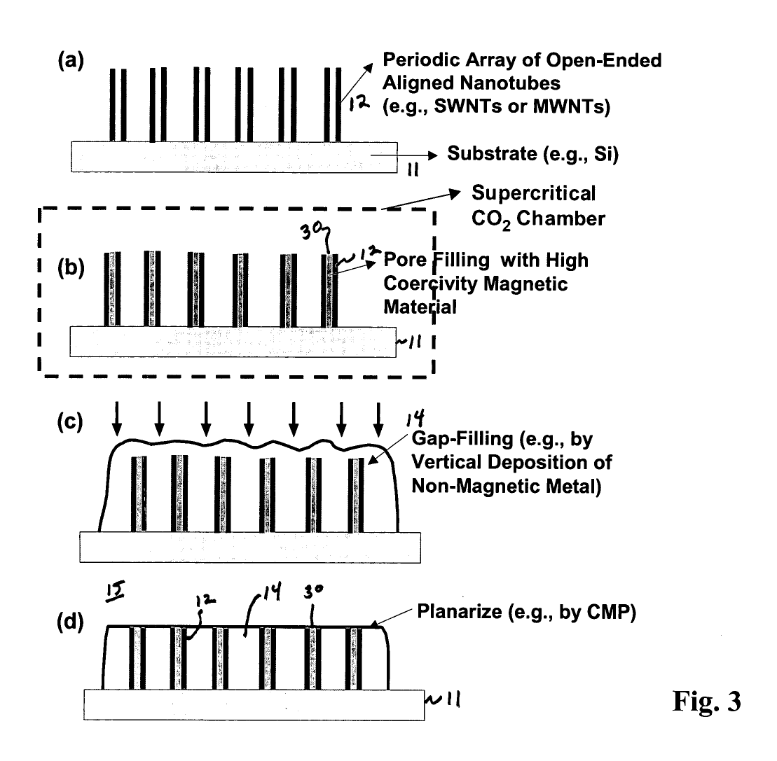

FIG. 2 is a schematic block diagram of an exemplary process of making the magnetic recording medium of FIG. 1 and FIG. 3 schematically illustrates stages of the processing method. The first step, shown in Block A of FIG. 1, is to provide a substrate having a plurality of nanowires, such as carbon nanotubes, disposed substantially perpendicular to a surface. Advantageously the nanowires are secured to the surface in a substantially regular (approximately periodically spaced) array. FIG. 3(a) illustrates the nanowires 12 grown on substrate 11.

In the second step, Block B, the substrate with aligned nanowires is processed so as to make an array of magnetic nanowires. For example if the nanowires are hollow nanotubes, the substrate can be placed inside a supercritical CO₂ deposition chamber, and the nanotubes made magnetic by filling their hollow cores with a high coercivity magnetic metal or alloy, such as Co, Co—Cr, Co—Cr—Ta, Fe—Pt, Co—Pt, rare earth cobalt, rare earth iron, or rare earth iron boron alloy. FIG. 3(b) shows hollow nanowires 12 filled with magnetic material 30.

The cores of nanotubes are desirably fully filled with magnetic material, at least to such length that the aspect ratio of the resulting nanomagnet is at least 3, and preferably at least 10. Such nanotubes filled with a magnetic material such as Ni have been reported, albeit without the desired alignment, by N. Grobert et al., Appl. Phys. Vol. A67, page 595 (1998), and by M. Terrones et al. in MRS Bulletin, August 1999 issue, page 43. The desired aligned and metal-filled carbon nanotubes can be obtained by control of nucleation and growth on a flat substrate to co-deposit metal and carbon nanotube simultaneously. The alignment can be accomplished by applying electric or magnetic field. In such a filled configuration, the diameter of nanomagnets can be even smaller, and a higher density of magnetic recording can thus be accomplished. However, too small a diameter may not be desirable because of the onset of superparamagnetic behavior. The magnetic metal filling inside a tube-shaped, non-magnetic nano material (not necessarily carbon nanotubes) desirably has a diameter of at least 0.5 nanometer, preferably at least 1 nanometer, even more preferably at least 3 nm. To fill the core of nanotubes with magnetic material, the tubes are desirably open at the top end. The nanotube tips can be opened by acid treatment or by localized burning in oxygen atmosphere. See Ajayan et al., Nature, Vol. 362, page 522, 1993, and Tsang et al., Nature, Vol 372, page 159, 1994.

While there are several ways of filling the nanotubes with a metal, the preferred way for the sake of reliability and uniform deposition is to use carbon dioxide supercritical fluid chemical deposition. The supercritical fluid behaves like a hybrid of liquid and gas. It can dissolve desired solutes like a liquid, and yet conveniently behave like a gas. It exhibits low viscosity, high diffusivity and high pressure for easy penetration into small pores. See an article by Darr, Chemical Review, Vol 99, page 495-542, 1999 and U.S. Pat. No. 6,132,491 issued to Wai et al on Oct. 17, 2000. An article by Ye, et al, Advanced Materials, Vol. 15, page 316, 2003 describes an example of supercritical fluid deposition of a metal inside carbon nanotubes. For magnetic recording media, filling of nanotubes is advantageously accomplished in a densely arrayed nanotube configuration with the nanotubes securely attached on a flat substrate, and the nanotube array is preferably immobilized and planarized in a solid form rather than in a free-moving nanotube shape. One exemplary processing of supercritical CO₂ fluid deposition involves the dissolution of metal-containing precursor such as metal(hfa)₂₂.xH₂O [where (hfa)=hexafluroacetyl-acetonate] in a mixture of CO₂ and H₂, which is then reduced by hydrogen in supercritical CO₂, followed by reaction time and then drying (removal) of CO₂. The reaction can be carried out at a slightly elevated temperature of for example, as high as 200-300° C. Another alternative way is to do the gap-filling and planarization first, and then to do the nanotube filling with magnetic metal.

In the third step, Block C of FIG. 2, the gaps between the nanowires are filled by a non-magnetic filler material, such as metal, alloy or a non-magnetic compound. This can be accomplished by physical vapor deposition (e.g. sputtering, evaporation or laser ablation) from a direction substantially perpendicular to the substrate, as illustrated in FIG. 3(c). The filler material can be chosen from a number of well known non-magnetic materials, such as Al, Ti, Si, Cu, Mo, Cr or their alloys, or their non-magnetic oxides, carbides, nitrides, silicides, or borides. It is preferred that the filler material have high mechanical hardness so that the finished recording media has a wear resistant surface. The preferred microhardness value of the recording media is at least 500 Kg/mm² and preferably at least 1000 Kg/mm² as measured by Vickers or Knoop indentation. As a reference, the microhardness of pure copper is on the order of ˜100 Kg/mm² and that of silicon nitride is ˜1500 Kg/mm². FIG. 3(c) illustrates the application of gap-filling material 14.

In the final step, Block D of FIG. 2, the outer surface of the gap-filled composite structure is planarized, for example, by known mechanical polishing techniques or by the chemical mechanical polishing (CMP) often used in modern silicon fabrication technology.

The resulting magnetic storage medium is schematically shown in FIG. 3(d) with surface 15 planarized. The medium has each of the nanoscale magnet element 12 exposed to the top surface for magnetic recording or read operations. The resultant magnetic recording media has a plurality of vertically aligned nanowire magnets embedded in a thin nanomagnetic layer 14 which is placed on a solid substrate 11. In this final product, the magnetic material can be in the form of a cylindrical coating (not shown) around the nanowires 12 rather than a solid magnetic rod. The cylindrical structure sacrifices some volume of magnetic material, but it enhances the aspect ratio of elongation in the magnetic material, thereby minimizing undesirable self demagnetizing. The desired range of nanomagnet diameter (outside diameter of the magnetic cylinder) is less than 100 nm, preferably less than 20 nm and even more preferably less than 10 nm. The desired height of the nanomagnet cylinder is advantageously in the range of 10-5000 nm, and preferably 50-500 nm. With the 10 nm size magnetic bit dimension corresponding to each of the nanomagnets present in the recording medium, the recording density is ˜10¹² or ˜1 terabits/square inch. The desired coercivity of the nanomagnet in the inventive process is at least 500 Oe, preferably at least 1000 Oe, even more preferably at least 3000 Oe so that even a small-diameter nanomagnet of less than 5 nm diameter can be useful without being subjected to superparamagnetic instability. The availability of such an ultra-high-density recording medium will be very useful in advancing information storage and management technologies.

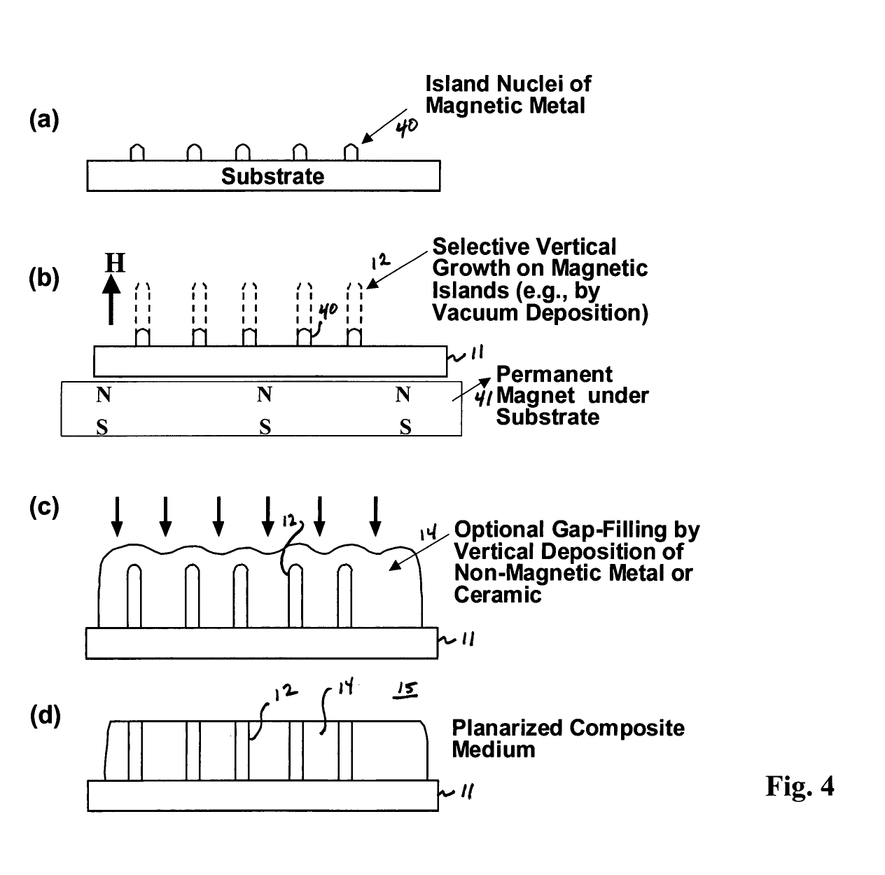

FIG. 4 illustrates an alternative way of fabricating a magnetic nanowire array structure. The first step, FIG. 4(a), is to create an array of nanoislands 40 made of ferromagnetic material, preferably a relatively soft magnetic metal or alloy. Such islands can be fabricated by a number of different techniques, e.g., lithographic processing such as extreme UV (ultraviolet) photolithography, projection electron beam lithography, nanopatterned stamping, probe-tip nanowriting (known as dip-pen lithography), or surfactant-coating of a self-assembled periodic array of magnetic nanoparticles such as Fe (see an article by Yamamuro et al, Physical Review B, volume 65, page 224431 (2002)).

Once a magnetic island array is formed, the next step is to transform the nanoislands into elongated nanowire shapes 12. The ferromagnetic nature of the nanoislands is utilized to enforce the nanowire growth in the subsequent physical vapor deposition such as sputtering or evaporation. When an external vertical magnetic field H is applied, e.g., 100-10,000 Oe field as by using a permanent magnet 41 as illustrated in FIG. 4(b) or an electromagnet, each of the soft magnetic islands is magnetized, the field is amplified by the magnetic islands. The tip of each island 40 serves as a magnetic pole, and during the subsequent sputtering or evaporation, the magnetic clusters are magnetostatically attracted to the pole to be deposited. Hence the nanowire growth occurs preferentially on the islands as illustrated in FIG. 4(b).

The individual atoms of ferromagnetic metal are generally nonmagnetic or superparamagnetic due to thermal instability. In order to be ferromagnetic and to respond to the applied magnetic field and to the pole field from nanoislands, the atoms need to cluster to a certain critical size of at least several atoms. In order to enhance the probability of such cluster formation, a specific evaporation or sputtering process is utilized. For example, very high pressure evaporation or sputtering is utilized so that evaporated or sputtered atoms bounce off many times and hence have time to form clusters which can respond to the magnetic field from the island tips. The desired gas pressure for the vacuum evaporation or sputtering is at least 0.001 torr, preferably at least 0.01 torr, and even more preferably at least 0.1 torr. Comparing to the typical vacuum in sputtering or evaporation, this pressure is many orders of magnitude higher.

The desired material for nanoislands 40 should be relatively magnetically soft with the coercivity in the range of 0.01-500 Oe, preferably 0.01-100 Oe, and even more preferably 0.01-20 Oe. Exemplary materials include Ni, Fe, Co, and their alloys (especially Ni—Fe permalloy which is a well known soft magnetic alloy), nanocrystalline magnetic alloys with low coercivities, or amorphous alloys such as Co—Fe—B. The desired magnetic material to be selectively deposited on top of the soft magnetic island poles should be a permanent magnet material with a relatively high coercive force to serve as recording media. Desired magnet materials to be grown on the soft magnetic islands include Co, Co—Cr, Co—Cr—Ta, Fe—Pt, Co—Pt, rare earth cobalt, rare earth iron, or rare earth iron boron alloy. The desired coercivity of such a nanowire material after all the processing steps are carried out is at least 500 Oe, preferably at least 1000 Oe, and even more preferably at least 3000 Oe. However, during the synthesis of nanowire by applied magnetic field, the growing nanowire does not have to exhibit high coercive force, and in fact, low coercive force values are preferred for the ease of magnetic attraction and attachment of magnetic clusters. The desired, final high coercive force can be obtained by annealing heat treatment after the nanowire growth is completed.

The finished composite material workpiece of FIG. 4(d) can optionally be subjected to post-deposition annealing treatment of at least 200 degrees C. for at least 10 minutes, and preferably at least 500 degrees C. for at least 1 hour, in order to relieve stresses, to homogenize the alloy composition (if alloys are deposited), and to produce desired crystal structure with desired magnetic characteristics.

The magnetic nanowire array of FIG. 4(b) itself can be used as a recording media without potting and planarization. For this purpose, the aspect ratio is kept intentionally somewhat low, e.g., less than 3, and preferably less than 2, so that a mechanical stability is maintained during magnetic recording and reading operations.

Having such a soft magnet base underneath the permanent magnet nanowire is additionally beneficial since it can enhance magnetic recording performance. The soft magnetic base serves to reduce the self demagnetizing effect and also provides flux return paths.

The magnetic nanowires so fabricated are then optionally assembled into a rigid composite structure as illustrated in FIG. 4(c). The gaps between the nanowires are filled by a non-magnetic filler material 14, such as metal, alloy or a non-magnetic compound. This can be accomplished by physical vapor deposition (e.g. sputtering, evaporation or laser ablation) from a direction substantially perpendicular to the substrate. The filler material can be chosen from a number of well known non-magnetic materials, such as Al, Ti, Si, Cu, Mo, Cr or their alloys, or their non-magnetic oxides, carbides, nitrides, silicides, or borides.

In the final step, FIG. 4(d), the outer surface 15 of the gap-filled composite structure is planarized, for example, by mechanical polishing or chemical mechanical polishing (CMP).

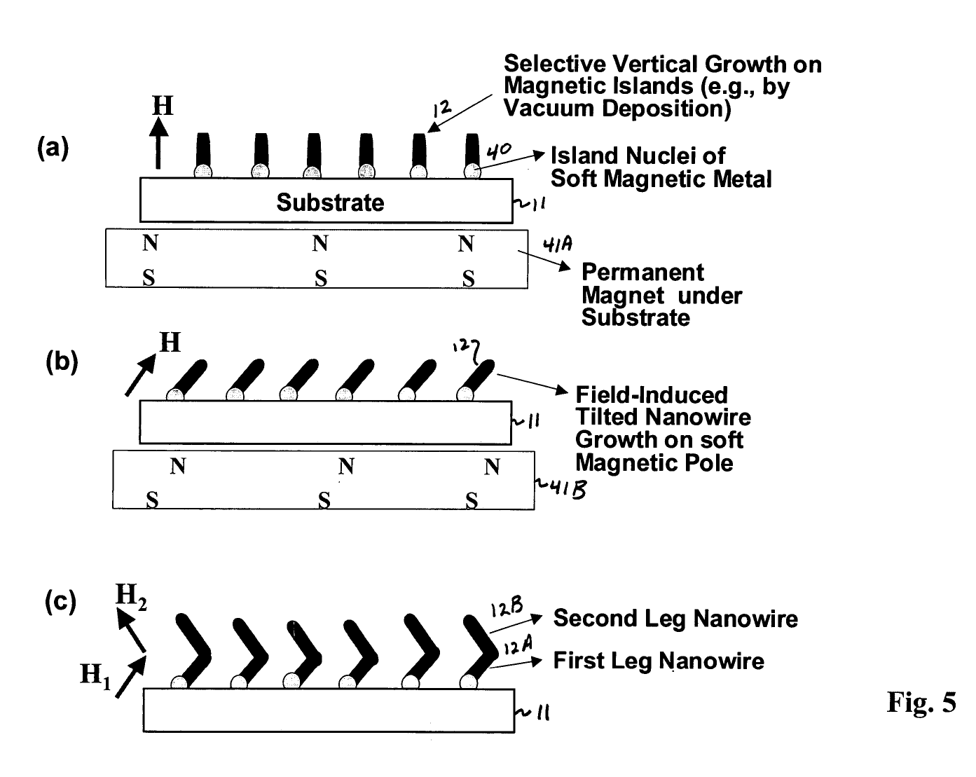

The nanomagnets of FIG. 4 can alternatively be made tilted, as shown in FIG. 5. The direction of the magnetic field applied to the soft magnetic islands is modified to the tilted orientation, as illustrated in FIG. 5(b), to cause impinging magnetic clusters to attach themselves to the nanoislands and grow along the field direction. By altering the direction of the applied magnetic field, as by replacement of the magnet 41A underneath the substrate with another one 41B having an inclined magnetization direction, or by using an electromagnet which can be tilted, the nanowire growth direction can be altered and a zig-zag magnetic nanowire 12A/12B can be grown as illustrated in FIG. 5(c).

Instead of nanowire arrays, a flat substrate with a recessed and vertically aligned pore array can be used to prepare the ultra-high-density nanomagnet array. Silicon substrates are flat and commercially available. Vertical nanopores in the regime of 2-20 nanometer diameter can be fabricated in silicon by known techniques. It has been shown that such pores can be filled with magnetic materials such as Ni or Fe—Co alloy, but the techniques previously used may not be suitable for this invention. See articles by Gusev et al, Journal of Applied Physics, Vol. 76, page 6671, 1994, and by Hamadache et al, Journal of Material Research, Vol. 17, page 1074, 2002. It is not clear what portion of the pore diameter or depth was filled with magnetic metal. The penetration of electrolyte into such a fine nano-scale diameter pores for electrodeposition is difficult because surface tension of a liquid tends to prevent it from getting inside pores especially nanopores. The reported magnetic properties by Gusev et al were rather poor and not suitable for magnetic recording media applications, as the coercivity value measured was only ˜200 Oe or less.

In this invention, carbon dioxide supercritical fluid chemical deposition, as described above, is advantageously used for meaningful and reliable deposition of nanomagnet into the porous silicon nanopores. High coercivity magnetic materials preferably with high magnetocrystalline anisopropy are used to fill up the nanopores.

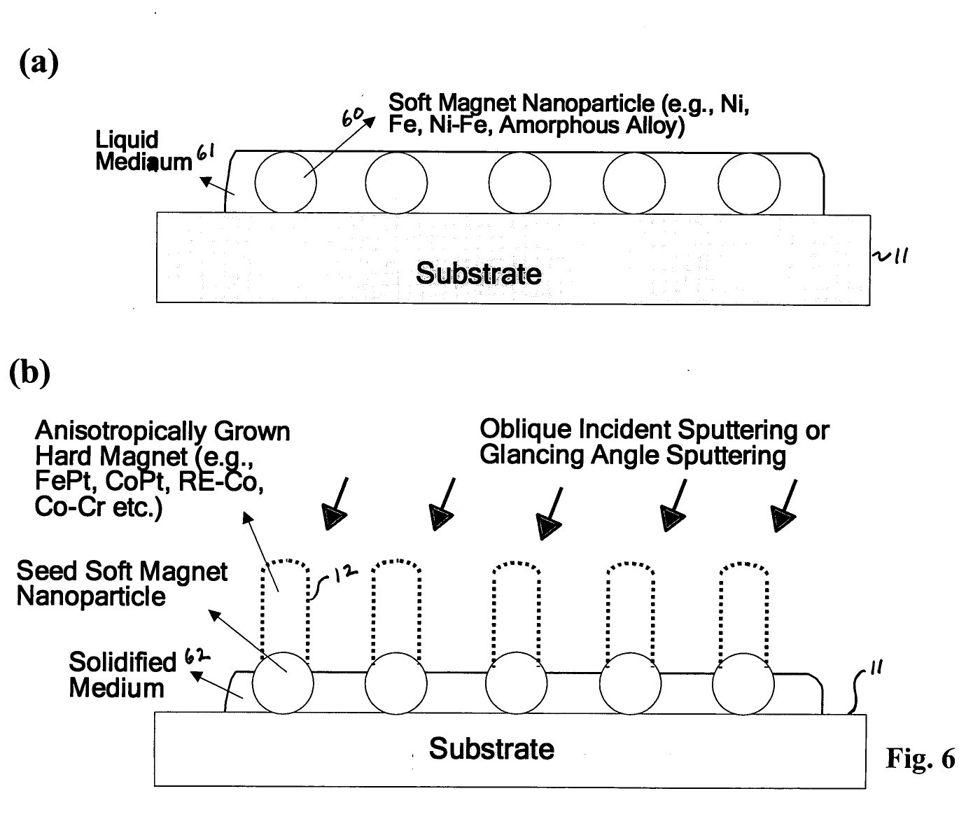

FIG. 6 illustrates using oblique incident deposition onto a planar array of nanoparticles 60 to create an elongated nanomagnet array. As an initial step, soft magnetic nanoparticles 60 are dispersed in a liquid medium 61 and applied to the surface of substrate 11. The medium 61 is advantageously a medium that will dry leaving a solid residue 62 to hold the particles 60 in place. The liquid 62 can be water-based with dissolved material such as salt, honey or glycerol. Or it can be based on other solvents with dissolved material, e.g. alcohol or acetone with polyvinyl alcohol. Alternatively it can be an organic surfactant such as fatty acids (e.g. oleic acid and oleylamine) in hexane.

As shown in FIG. 6(b), after drying, magnetic material is deposited on the particles. Thin film deposition of magnetic metal or alloy from an oblique incident direction of sputtered or evaporated atoms tends to form elongated structures because 12 of self-shadowing effect. The desired angle of oblique incidence is at least 30 degrees off the straight vertical direction, preferably at least 60 degrees, even more preferably at least 80 degrees to maximize the shadow effect. Building onto the existing nanoparticle array in this manner, a nanomagnet array is fabricated. The elongated nanomagnet array can be used as is for the recording media, or it can be coated with nonmagnetic gap filler followed by planarization similarly as in FIGS. 4(c) and (d). Optionally, the orientation of the oblique incident vacuum deposition can be changed during growth to vary the orientation of the nanomagnets.

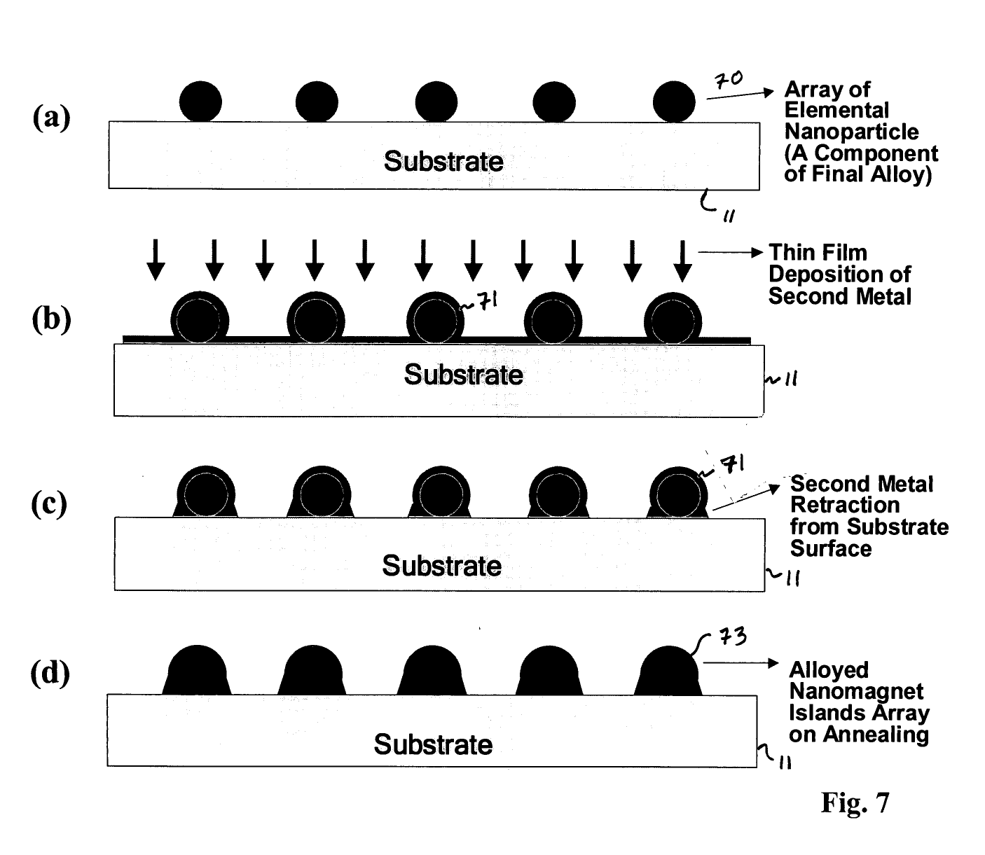

Yet another variation of inventive method of utilizing a planar array of nanoparticles of elemental metal to form an eventual alloy nanomagnet array is illustrated in 7. In this case, an array of nanoparticles 70 is utilized as a basis to add a second metal 71, FIG. 7(b). The metal island nanoparticles 70 preferably have a particle size in the range of 1-30 nm, referably 1-10 nm, preferably with a mono-disperse particle size distribution with a periodic planar arrangement on the substrate. A layer of a second metal 71 is applied over the array by thin film deposition. The structure is then heated to a high temperature to impart mobility to atoms (or alternatively, the substrate can be heated during thin film deposition). The second metal 71, if chosen properly so as to have a differential surface wetting (or surface chemical reactivity) onto substrate as compared to the nanoisland metal material, then retracts from the non- or less-wettable substrate surface and agglomerates around the first metal nanoparticles. Exemplary materials for the first metal 70 include Ni, Fe, Co, Pt. Examples of second metal 71 include Pt, Fe, Co, Ni, rare earth element, as well as alloys such as Co—Cr, Co—Cr—Ta, Fe—Pt, Co—Pt, rare earth cobalt, rare earth iron, or rare earth iron boron.

As an example, an array of Pt nanoparticles 70 can be placed on the substrate using surfactant to separate and periodically arrange the particles (FIG. 7(a)), then Fe 71 is sputter deposited (FIG. 7(b)), and the composite structure is then annealed (FIGS. 7(c) and (d)) to form an array of L1ₒ phase Fe—Pt nanoislands 73 with desired high coercivity. Another example is the placement of an Fe nanoparticle array on the substrate followed by Pt film deposition and annealing to form the desired L1ₒ. phase Fe—Pt nanoislands array. The desired annealing temperature is at least 300° C., and preferably at least 600° C. Optionally a partial reaction (especially if an excess amount of Fe is present in the base islands as compared to the overall stoichiometric Fe:Pt atomic ratio of 1:1 in the composite structure) can produce an array of dual-structured nanomagnets. The dual structured nanomagnets are nanoislands with soft magnetic, unalloyed Fe portions at the bottom and alloyed, high-coercivity Fe—Pt recording media regions at the top.

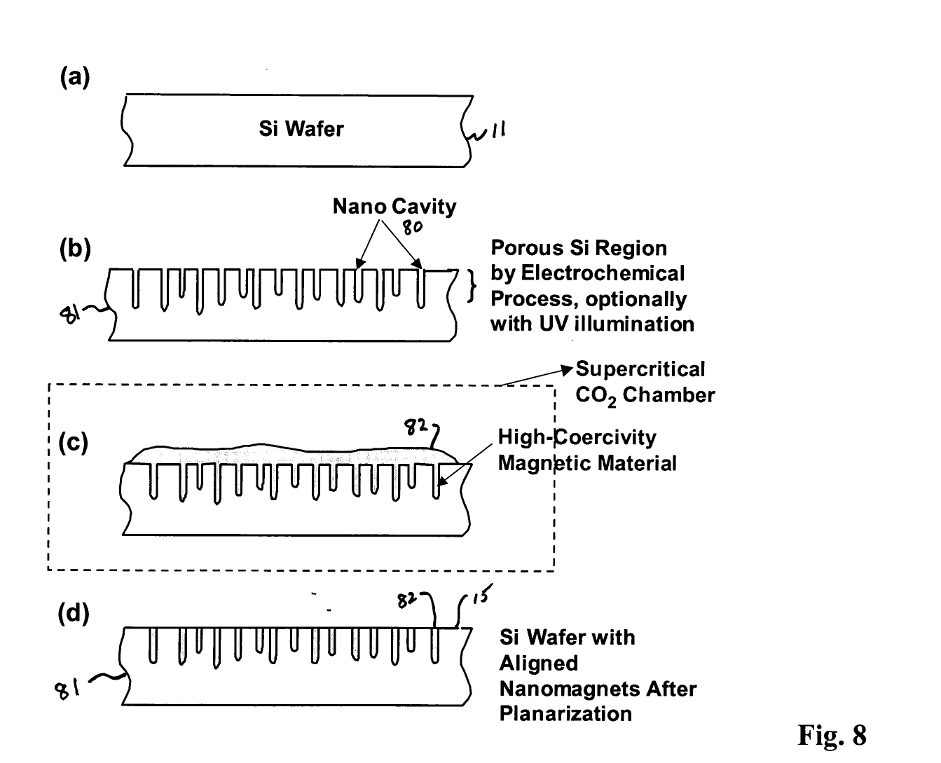

FIG. 8 schematically illustrates an alternative method of fabricating an ultra-high-density magnetic recording media by forming vertical nanopores 80 a substrate 11 and filling vertical nanopores 80. Porous silicon 81 can be fabricated by chemical or electrochemical etching, optionally with UV illumination to promote a more vertical pore configuration. The nanocavities (or nanopores) 80 are then filled with desired magnetic nanomagnet material 82 as by using supercritical carbon dioxide deposition (FIG. 8(c)), and planarized as by using chemical or mechanical polishing (FIG. 8(d)). The nanopores do not have to be filled completely, as long as the aspect of the filled nanomagnet material is at least 2, preferably at least 5 so as to give some shape anisotropy and increased volume to help minimize the superparamagnetic behavior in small diameter nanomagnets. The desired diameter of the nanopores is in the range of 1-30 nm, and preferably in the range of 1-10 nm for the sake of high recording density.

Examples of desirable nanomagnet materials to be supercritically filled in the silicon nanopores include Fe, Co, Ni, rare earth elements and alloys such as Co—Cr, Co—Cr—Ta, Fe—Pt, Co—Pt, rare earth cobalt, rare earth iron, or rare earth iron boron. High coercivity metal and alloys are preferred for magnetic bit stability.

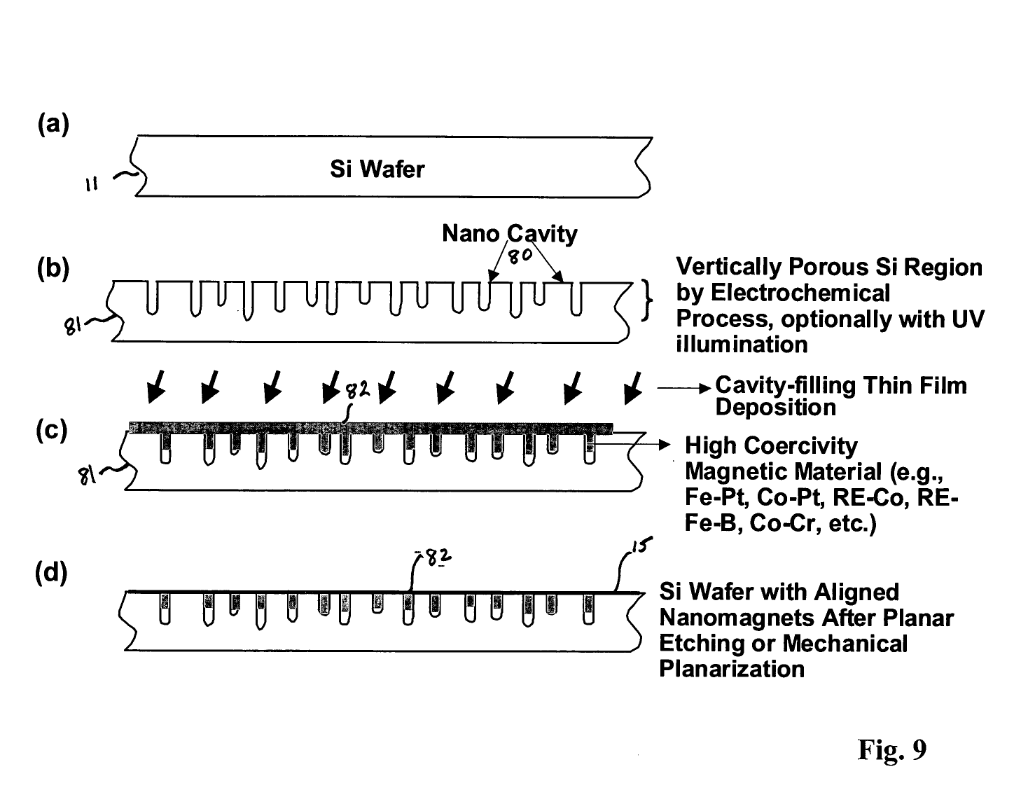

FIG. 9 schematically illustrates nanopore filling approach using physical vapor deposition. The vertical nanopores 80 in the porous Si 81 are filled by sputtering or evaporating magnetic material 82. A slight oblique incident angle, e.g., at least 2 degrees, preferably at least 10 degrees is advantageous to ensure the deposition of the magnetic metal on nanopore inside walls. The top surface of the porous Si is also coated with magnetic alloy film as illustrated in FIG. 9(b). This surface film should be removed in order to create a nanomagnet array. The top surface metal deposit can be polished away via planarization (chemical or mechanical polishing) (FIG. 9(d)). Because the surface tension of acid solution liquid resists going to go into nanopores, chemical etching produces a selective etching of the top layer of metal.

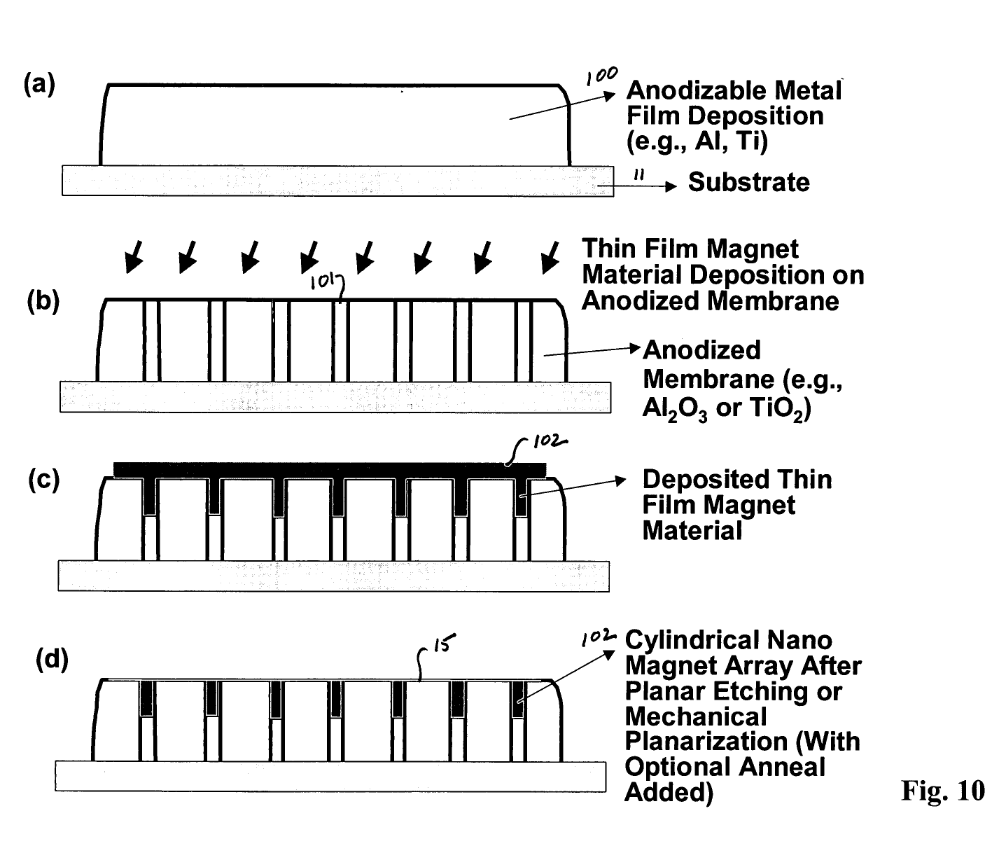

Instead of porous silicon, other types of membrane materials with vertically aligned nanopores can also be used for the physical vapor nanopore filling. Illustrated in FIG. 10 is a method of filling anodized alumina, one of the very well known nanomembrane materials. The first step is to deposit a thin aluminum or titanium layer 100 on a flat substrate 11 such as Si as illustrated in FIG. 10(a). The deposition can be carried out by e.g., sputtering or evaporation, with a desired thickness of ˜50-5000 nm. The metal film 100 is then anodized in an acid by applying a voltage. An oblique incident thin film deposition is then applied to the anodized film 91 to fill the nanopores 101 with desired high coercivity magnetic material 102, as shown in FIGS. 10(b) and (c), followed by planarization to remove the surface metal, FIG. 10(d).

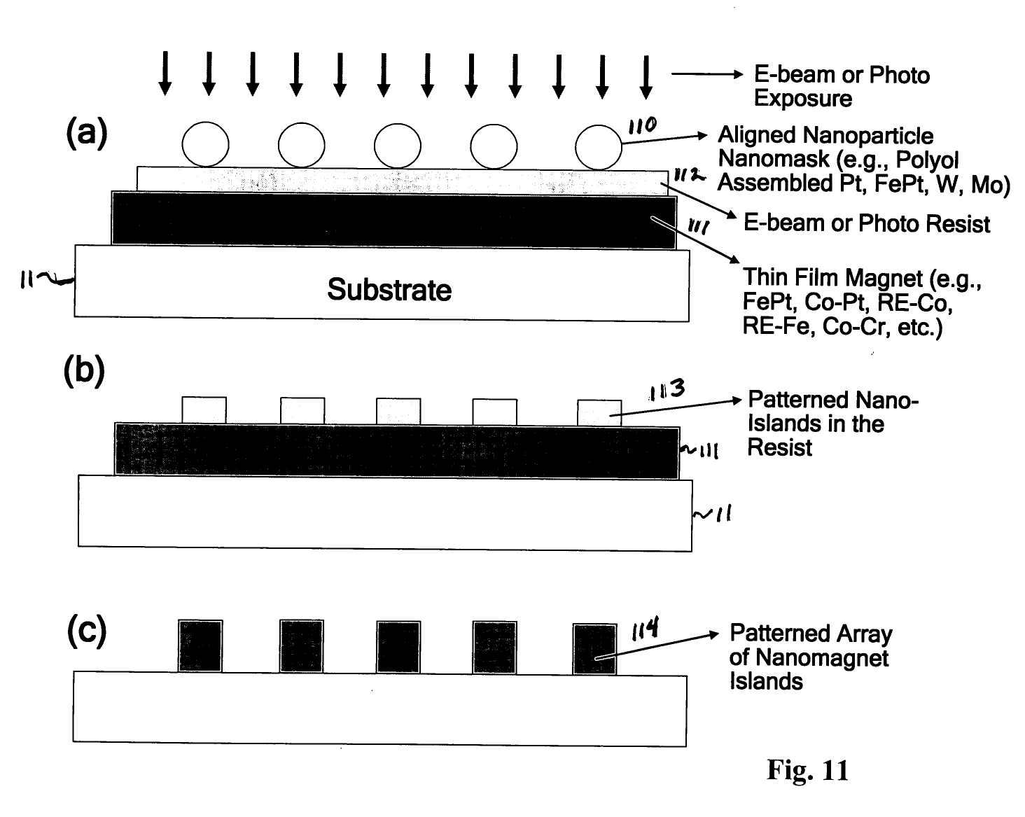

FIG. 11 illustrates yet another method for obtaining a nanomagnet array using nanoparticle array. The nanoparticles 110 can be placed on a flat substrate of Si 11 as a surfactant-separated, self-assembled periodic array such as described by Yamamuro et al, Physical Review B, volume 65, page 224431 (2002). The nanoparticles are themselves used as nanomasks for projection e-beam, extreme UV, or ArF lithography.

The first step is to deposit a magnetic film 111 comprising a high-coercive force permanent magnet recording material such as Co—Cr, Co—Cr—Ta, Fe—Pt, Co—Pt, rare earth cobalt, rare earth iron, or rare earth iron boron.

Referring back to FIG. 11, the second step is to deposit e-beam or photo-resist layer 112, e.g., by using a well known spin coat technique, in the desired thickness regime of 10 to 500 nm.

The third step is to apply the nanoparticles 110 onto the surface of the resist layer 112 as a mono-layer. The liquid containing the nanoparticles of metals or ceramics such as Pt, Co, Ni, Fe, W, Mo, Fe₂O₃, TiO₂, and SiO₂ are dispensed on the substrate surface, e.g., using spin coating technique. For the desired periodic arrangement, the particles are preferably coated with a surfactant such as a fatty acid type material, e.g., oleic acid and oleyamine. The dispersed particles 110 are allowed to dry before beam exposure. The residual fatty acid material in the vicinity of dried nanoparticles transmits electrons or optical beams much better than metal or ceramic particles, so the residual material does not hinder the nanoparticle-mask lithography.

After exposure of the resist layer with e-beam or optical beam, the resist is developed into nano island patterns 113 as illustrated in FIG. 11(b). Subsequent etching of the underlying metal and dissolution of the remaining resist mask results in a nanomagnets 114 as shown in FIG. 11(c).

The spaced nanomagnet array of FIG. 11(c) can be geometrically improved by the further steps of filling the gaps between the nanomagnets with non-magnetic filler and planarizing the composite material into a flat-surfaced recording media.

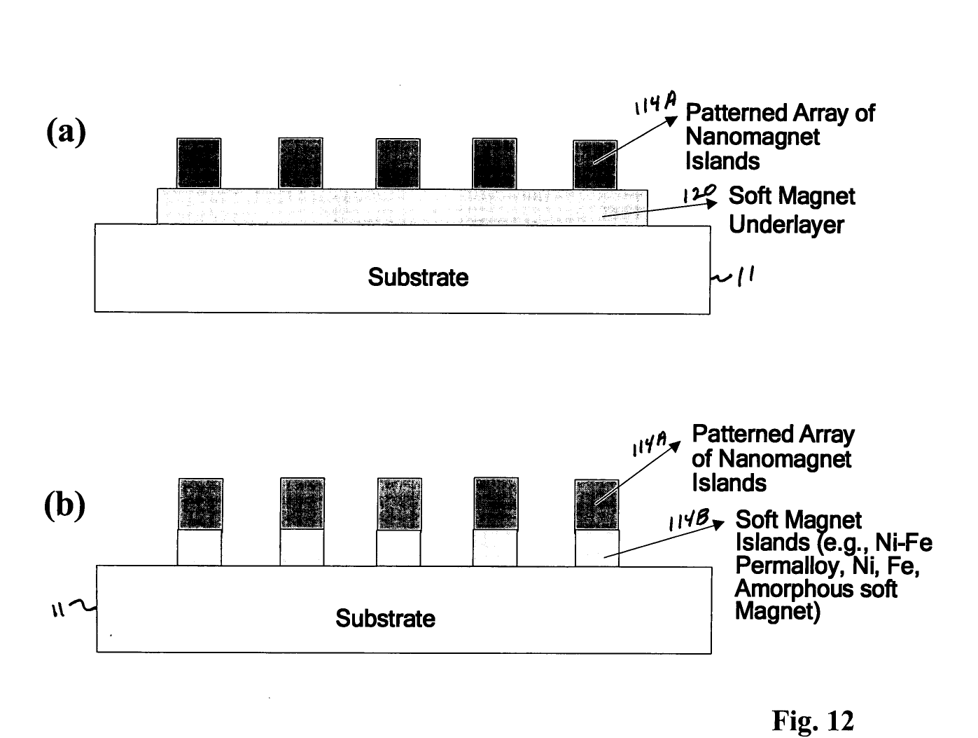

FIG. 12 illustrates a modification of the FIG. 11 process using a composite magnetic film 111. Optionally, magnetic film 111 is a composite layer that includes a soft magnet underlayer 120 such as Ni—Fe permalloy, Fe, Ni or Co—Fe—B amorphous soft magnet materials, with a desired thickness range of 10-10,000 nm, and preferentially 10-500 nm. The soft magnet layer can be deposited prior to the deposition of the hard magnet layer, so that the soft magnet layer or islands are formed under the nanomagnet islands as illustrated in FIGS. 12(a) and (b) respectively. This improves the recording efficiency. Optionally, the soft magnetic layer can be coated with a very thin layer of a chemical-etch-resistant material such as 1-100 nm thick Cr, Al, Au, Pt, Pd to prevent it from getting etched into nano islands for the structure of FIG. 12(a). If there is natural difference in the degree of chemical etching between the permanent magnet layer material and the soft magnetic material, such an additional layer can be omitted.

In order to serve as a magnetic recording medium and store information with stability, the nanomagnet array in this invention should have a high magnetic coercivity and desirably a high magnetization squareness ratio (defined here as the ratio of remanent magnetization over the saturation magnetization). The desired value of coercivity for the inventive ultra-high-density recording media is in the range 500-6000 oersteads, and preferably in the range of 1000-3000 Oe. The desired squareness is at least 0.7, and preferably at least 0.9. High magnetic saturation of at least 2000 gauss is desirable, preferably at least 8000 gauss. Materials with high magnetocrystalline anisopropy such as the Fe—Pt alloy compound with the L1ₒ phase, Co—Pt, rare earth cobalt or rare earth iron based compounds, hexaferrites, cobalt based alloy materials are preferred.

The as-deposited nanomagnet material in the nanopores or on the flat substrate according to the invention may not have desirable crystal structure and magnetic properties due to the defective crystal formation for deposition at or near ambient temperature. Post-deposition annealing treatment of at least 200 degrees C. for at least 10 minutes, and preferably at least 500 degrees C. for at least 1 hour can restore and maximize the magnetic properties of the deposited material. A neutral or inert gas atmosphere such as argon or nitrogen, a reducing atmosphere such as a hydrogen-containing gas, or a mixed gas at various compositions can be used for the annealing treatment with minimal oxidation of the magnetic metals involved.

While high coercivity materials provide more stability of magnetically recorded information bits, writing on high coercivity recording media with a given magnetic field from the magnetic write head can be a problem. For high coercivity materials with coercivity values in excess of ˜2000 Oe, thermally assisted magnetic recording can be used. Here, a laser pulse can be applied to heat a local region so that the coercivity is momentarily lowered by the local heating and magnetic switching (writing) is done with the available write field.

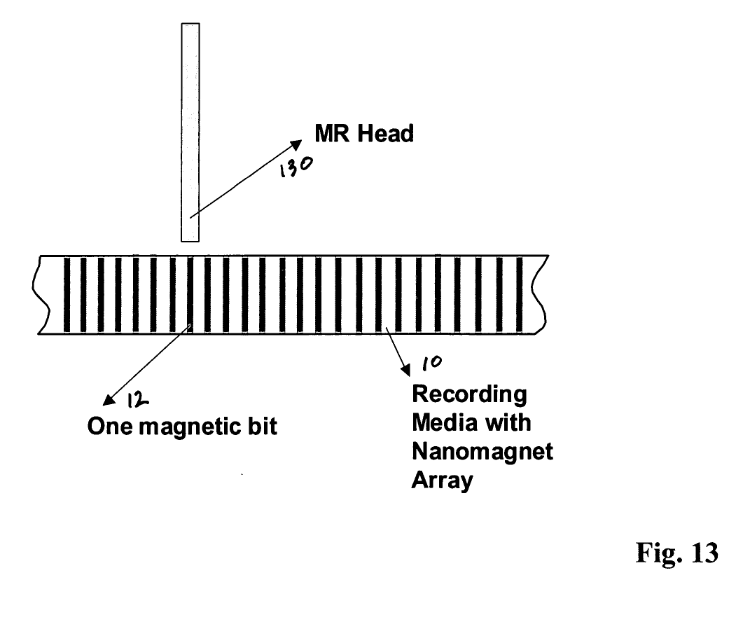

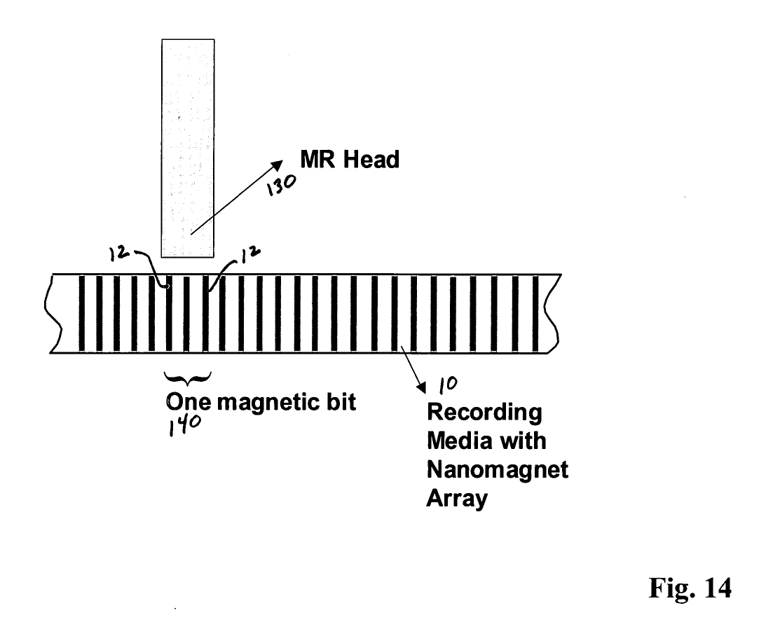

Referring to FIG. 13, one way of recording magnetic bit information on the inventive ultra-high-density recording media is to use each nanomagnet 12 as a unit of written bit, for example magnetizing with its north pole up vs the other nanomagnets in the neighborhood having their south poles up. This approach makes the maximum use of available number of nanomagnets, and hence provides the highest recording density. For such applications, the alignment and registry of the read/write head 130 with respect to each of the nanomagnet bit location are critical for both writing and reading. An alternative way of operating the inventive ultra-high-density recording media is to use several nanomagnets collectively as one recorded bit 140, as illustrated in FIG. 14. The desired number of nanomagnets per written bit is at least 2, preferably at least 5, but not more than 20 for the sake of keeping the recording density reasonably high.

In both modes of operations (FIG. 13, FIG. 14), the uniformity of nanomagnet distribution is essential, as nonuniform nanomagnets can cause the undesirable variations of magnetic write reliability and read signals, and even a total absence of magnetic bits where the nanomagnet density happens to be unusually low. For maximizing the uniformity of nanomagnet distribution, a periodic arrangement of nanomagets is desired. The desired range of nanomagnet diameter in the inventive, nanomagnet recording media materials is less than 100 nm, preferably less than 20 nm, even more preferably less than 10 nm. The desired height of the nanomagnet cylinder is in the range of 10-5000 nm, and preferably 50-500 nm. With the 10 nm size magnetic bit dimension corresponding to each of the nanomagnets present in the recording medium, a very high recording density is in excess of ˜10¹² or 1 terabits/square inch can be obtained.

It is understood that the above-described embodiments are illustrative of only a few of the many possible specific embodiments which can represent applications of the invention. Numerous and varied other arrangements can be made by those skilled in the art without departing from the spirit and scope of the invention.

1. A method of making a high density magnetic recording medium comprising the steps of:
providing a substrate;
disposing on the substrate a plurality of spaced, non-elongated nuclei, particles or islands;
growing vertically aligned and elongated high-coercivity nanomagnets starting from the nuclei, particles or islands;
filling the space between the nanomagnets with non-magnetic filler material; and
planarizing the filler material.

2. The method of claim 1 wherein the nanomagnets comprise material selected from the group consisting of Co—Cr, Co—Cr—Ta, Fe—Pt, Co—Pt, rare earth cobalt, rare earth iron, rare earth iron boron, and hard ferrite.

3. The method of claim 1 wherein the aligned nanomagnets are formed by growing hollow nanowires on the nuclei, particles or islands and introducing magnetic material into the hollow nanowires.

4. The method of claim 3 wherein the magnetic material is introduced into the hollow nanowires by supercritical carbon dioxide deposition.

5. The method of claim 1 wherein the aligned nanomagnets are formed by growing nanowires from the nuclei and coating the nanowires with magnetic material.

6. The method of claim 1 wherein the nuclei, particles or islands are composed of magnetic material and the aligned nanomagnets are formed by vacuum deposition of magnetic material under the influence of an external magnetic field to control the orientation of growth.

7. The method of claim 6 wherein the orientation of the external magnetic field is changed during growth to vary the orientation of the nanomagnets.

8. The method of claim 6 wherein the aligned nanomagnets are formed by the deposition of magnetic material by oblique incident sputtering or evaporation.

9. The method of claim 8 wherein the orientation of the oblique incident deposition is changed during growth to vary the orientation of the nanomagnets.

10. The method of claim 1 wherein the plurality of spaced nuclei, particles or islands comprise particles of magnetic material disposed on the substrate in a liquid dispersion.

11. The method of claim 10 wherein the liquid comprises a solvent including dissolved material to hold the particles in position upon evaporation of the solution.

12. The method of claim 1 wherein the spaced nuclei, particles or islands are disposed on the substrate by disposing on the substrate a plurality of spaced metallic particles, coating the particles with a continuous second metallic layer and heating the particles and the second layer to form alloyed and mutually-separated islands of magnetic alloy.

13. An article comprising a high density magnetic recording medium made by the process of claim 1.

14. A method of making a high density magnetic recording medium comprising the steps of:
providing a substrate having a plurality of aligned pores of nanoscale cross section;
disposing magnetic material in the pores by supercritical carbon dioxide deposition; and
planarizing the surface of the substrate.

15. The method of claim 14 wherein the substrate comprises silicon made porous by electrochemical etching.

16. The method of claim 14 wherein the electrochemical etching is effected under UV illumination.

17. The method of claim 14 wherein the substrate comprises an aluminum oxide membrane and the plurality of pores are in the membrane.

18. An article comprising a high density magnetic recording medium made by the process of claim 14.

19. A method of making a high density magnetic recording medium comprising the steps of:
providing a silicon substrate having a plurality of aligned pores of nanoscale cross section;
disposing magnetic material in the pores by thin film deposition; and
planarizing the surface of the substrate.

20. The method of claim 19 wherein the magnetic material is disposed in the pores by oblique incident thin film deposition.

21. An article comprising a high density magnetic recording medium made by the process of claim 19.

22. A method of making a high density magnetic recording medium comprising the steps of:
disposing an anodizable metal film on a substrate;
anodizing the metal film to form in the film a plurality of vertically aligned pores of nanoscale cross section;
disposing magnetic material in the pores by supercritical carbon dioxide deposition; and
planarizing the metal-filled film.

23. The method of claim 22 wherein the magnetic material is disposed in the pores by thin film deposition.

24. An article comprising a high density magnetic recording medium made by the process of claim 23.

25. A method of making a high density magnetic recording medium comprising the steps of:
disposing overlying a substrate a layer of magnetic material;
disposing a layer of resist overlying the magnetic material;
disposing a plurality of spaced nanoparticles overlying the resist;
exposing the resist to activating radiation using the nanoparticles as masks;
developing the resist; and
using the developed resist as an etch mask, etching the layer of magnetic material to form a plurality of spaced nanoscale magnets.

26. The method of claim 25 wherein the magnetic material is high-coercivity magnetic material.

27. The method of claim 25 wherein the magnetic material comprises a material selected from the group consisting of Co—Cr, Co—Cr—Ta, Fe—Pt, Co—Pt, rare earth cobalt, rare earth iron, rare earth iron boron, and hard fettite.

28. The method of claim 25 wherein the radiation comprises electron beam radiation and the resist comprises electron beam sensitive resist.

29. The method of claim 25 wherein the radiation comprises optical radiation and the resist comprises photo-sensitive resist.

30. The method of claim 25 wherein the layer of magnetic material comprises a composite layer including a high-coercivity magnetic material and an underlayer of soft magnetic material.

31. The method of 25 further comprising the steps of filling the gaps between the spaced nanomagnets with non-magnetic filler and planarizing a surface of the resulting structure into a flat-surfaced recording medium.

32. An article comprising a high density magnetic recording medium made by the process of claim 31.
